(19) United States
(12) Patent Application Publication
(10) Pub. No.: US 2018/0039694 A1
(43) Pub. Date: Feb. 8, 2018

(54) Method and apparatus for targeting, culling, analyzing, and reporting especially large volumes of numerical records from alphanumeric documentation within a single application

(71) Applicant: Perry H. Beaumont, Ridgefield, CT (US)

(72) Inventor: Perry H. Beaumont, Ridgefield, CT (US)

(21) Appl. No.: 15/229,472

(22) Filed: Aug. 5, 2016

(51) Int. Cl. G06F 17/30

(52) U.S. Cl. CPC G06F 17/30699; G06F 17/30011

(57) ABSTRACT

This invention relates to a method and apparatus for targeting, culling, analyzing, and reporting especially large volumes of numerical records from alphanumeric documents within a single application. The contributions of the present invention include, though are not limited to, its ability to target numerical records of relevance, culling those targeted records from documentation containing alphanumeric elements, achieving this with reference to a single document or multiple documents in batch mode, having statistical analyses performed with reference to the culled data and with results of those analyses available within various types of output documentation inclusive of a results report, an audit trail report, and a batch report if applicable. All these tasks are automated and contained within a single application that may reside on a personal computer, mainframe, mobile device, or the internet. The invention may be used on a standalone basis independent of other applications, and may be integrated with existing or future tools as a complement to data analysis functionality.

### BACKGROUND OF THE INVENTION

The present invention permits a user to upload documentation containing a mix of text and numbers, which the invention references to cull targeted numerical records for analysis and reporting. Documentation may be uploaded as a single file or in batch mode, and the invention automatically parses among all manner of alphanumeric information to identify only those particular numerical records of relevance to data analysis methods such as Benford's Law, or Zipf's Law. As established within existent literature, not all numerical information is applicable for analysis in the context of Benford's Law or Zipf's Law. Examples of non-applicable data would include records associated with physical limitations, as with number of airline passengers per plane, numbers reported in fixed formats as with phone numbers, numbers generated by formulae as with insurance policy references, and data forced to be a minimum or maximum value as with three-digit area codes or five-digit zip codes. The present invention addresses the importance of numerical exceptions by explicitly providing for a mechanism whereby only relevant numerical information is referenced. As such, a user can upload a company annual report which generally reflects a mix of financial data and commentary, and the present invention will hone in on the pertinent financial records to the exclusion of extraneous numerical information.

By virtue of the present invention's ability to reference the pertinent records among a mix of characters and formats, the potential for human error is minimized, the expenditure of time and effort is reduced, and the ability to subsequently apply collected data to a variety of complementary applications is enhanced. And while forensic or digital analysis is often linked with the fields of finance or accounting, there are many other applications including survey analysis, the review of statistics embedded within medical studies, and evaluating election results, among others.

Statistics can be a challenge for many persons within any context, though perhaps especially so when statistical tests are applied to advanced data analysis methods such as Benford's Law and Zipf's Law. Benford's Law and Zipf's Law each offer theoretical expectations for the distribution of digits within sets of numbers, and can help to flag anomalies when observed numerical profiles do not conform with theoretical expectations. When an evaluation is made to test a given dataset's conformity with Benford's Law, Zipf's Law, the Pareto Distribution, or other data analysis methods, statistics are often used to assist with that judgment process. As such, Z-statistics, Chi-square, Kolmogorov-Smirnoff, and Mean Absolute Deviation each offer perspectives of how well a dataset conforms with data analysis methods such as Benford's Law or Zipf's Law on a statistically significant basis. Specifically, Z-statistics are useful to the extent that they permit an evaluation of statistical significance on a digit-by-digit basis (as with first digit analyses) or digits-by-digits basis (as with first two digits analyses), whereas Chi-square, Kolmogorov-Smirnoff, and Mean Absolute Deviation are metrics of relevance to all numbers at once. That is, a single value is separately calculated for Chi-square, Kolmogorov-Smirnoff, and Mean Absolute Deviation per dataset, whereas multiple Z-statistics are generated per dataset.

Other statistical insights are additionally available beyond those already cited, as with the Mantissa Arc and Summation test, to name only a couple. For present purposes an exhaustive recitation of data analysis methods and statistical tests will not be enumerated here, rather our attention is focused on Benford's Law as a data analysis method, and on Z-statistics, Chi-square, Kolmogorov-Smirnoff, and Mean Absolute Deviation as tests for statistical significance. In doing this, however, the applicability of other data analysis methods and statistical tests are not intended to be excluded from the scope of the present invention.

To assist a user with analytic interpretations, statistical results are reported in the color red if they are not statistically significant relative to expectations of Benford's Law. As an additional step to assist users with interpreting complex results, statistical results are synthesized into a single scalar solution referred to as a Composite score. The Composite score ranges in value from one to three, and readily flags whether a given dataset is statistically consistent with expectations of Benford's Law. By way of one example involving first digits, the expectations of Bedford's Law would be the following proportions of occurrences among all nine digits, beginning with digit 1: {30.1%, 17.6%, 12.5%, 9.7%, 7.9%, 6.7%, 5.8%, 5.1%, 4.6%}. The expectations of Zipf's Law according to one preferred embodiment would be the following proportions of occurrences for first digits, beginning with digit 1: {35.3%, 17.7%, 11.8%, 8.8%, 7.1%, 5.9%, 5.0%, 4.4%, 3.9%}. Tables and formulae for observing or generating additional series of expected values in the context of Benford's Law and Zipf's Law are available within existent literature.

Another contribution of the present invention is in the context of divining statistical significance as this relates to especially large datasets. A bias can permeate certain statistical results when large datasets are involved, as with the excess power problem for Chi-square. The present invention's two-part solution to this problem is to first divide particularly large datasets into smaller subsets which are tested for statistical significance on an intra-subset basis, and to then test the statistical significance of the subsets on an inter-subset basis. To assist users with evaluating results of statistical tests performed on subsets, another scalar solution is offered in the form of a Subset score, and it also ranges in value from one to three. The Subset score readily flags whether especially large datasets appear to be statistically consistent on the basis of subset attributes in relation to norms set by Benford's Law.

Another benefit of the present invention is its audit trail capabilities. That is, an Audit Trail Report is generated with each analysis, and this report provides a detailed analytical profile for each page of input documentation. With input documentation capable of running into the hundreds of pages, an audit tracking ability can be of significant value. For example, if outliers can be readily identified on pages 10 to 20 of a 300-page document, considerable time and effort can be saved by going directly to the records in question.

Yet another benefit of the present invention is its automatic generation of text, charts, and tabular data when output documentation is created. Specifically, a Results Report includes summary information in text, tabular, and chart formats, and assists the user with obtaining a clear and concise overview of the dataset that has been analyzed.

Finally, the present invention may be used on a standalone basis independent of other applications, and may be integrated with existing or future tools as a complement to data analysis functionality. For example, the present invention could represent a complementary component of eDiscovery software, audit software, and accounting or books and records software, among others.

The present disclosure addresses the incompleteness of existing solutions by introducing an advanced statistical rigor of analyses with accompanying color-coded guides and synthesized scoring metrics to facilitate interpretations, by expanding data analysis methods beyond Benford's Law to additionally include Zipf's Law, and by creatively addressing the problem of bias introduced by large datasets. Regarding existing art, for a method of identifying non-conforming numerical records, U.S. Pat. No. 9,058,285 to Kossovsky, incorporated by reference herein for all purposes, relies upon regression for the determination of statistical significance. There have also been inventions related to statistical models for the fitting of results with reference to Benford's Law where large number biases are not a factor, as with U.S. Pat. No. 7,940,989 to Shi et. al.

### BRIEF DESCRIPTION OF THE DRAWINGS

Preferred embodiments of the present invention will now be described, by way of example only, with reference to the following drawings in which:

FIG. 1 is a flow diagram of a process of a preferred embodiment at a high level;

FIG. 2 is a screen shot of a User Interface, allowing a user to interact with electronic devices to set up and run the application;

FIG. 3 is an example of a Results Report generated by the application, with displays of information in text, tabular, and chart formats, and statistical results relating to numerical records culled from input documentation;

FIG. 4 is an example of an Audit Trail Report generated by the application, with a detailed profile of statistical results pertaining to each page of input documentation, as well as an aggregated profile of statistical results pertaining to input documentation in aggregate;

FIG. 5 is an example of a Batch Report generated by the application, with a high level summary of each file analyzed within a batch process; and

FIG. 6 is a flow diagram of a process of a preferred embodiment at a detailed level.

### DETAILED DESCRIPTION

The present invention may be a system, method, application, or computer program. The computer program may include a computer readable storage medium or media having computer readable program instructions for causing a processor to implement features of the present invention. The computer readable storage medium may be a tangible device that can retain and store instructions for use by an instruction execution device. The computer readable storage medium may be a part of, but is not limited to, a personal computer, mainframe, mobile device, and the internet.

Computer readable program instructions described herein can be downloaded to respective computing/processing devices from a computer readable storage medium or to an external computer or external storage device via a network, the internet, a local area network, a wide area network, or a wireless network.

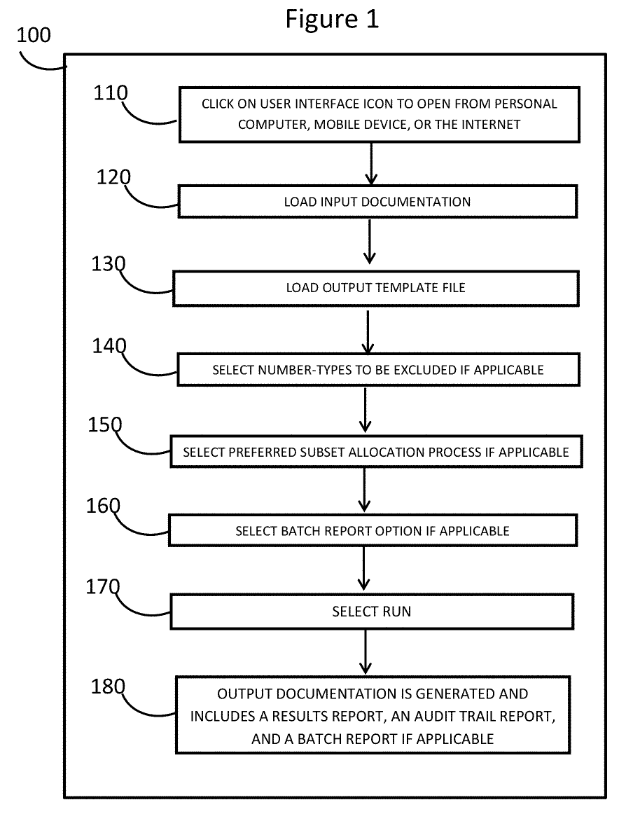

FIGS. 1 through 6 illustrate the architecture, functionality, and operation of possible implementations of systems, methods, applications, and computer program products according to various embodiments of the present invention. In this regard, each block in the flowcharts or block diagrams may represent a module, segment, or portion of instructions, which comprises one or more executable instructions for implementing the specified logical function.

The present invention references Benford's Law as a data analysis method. A simple definition of Benford's Law is that it posits theoretical expectations for a distribution of particular types of numbers. The theoretical expectations extend not only to every digit of a number, as with the first digit, second digit, and so on, but also to the first two digits of a number, the first three digits of a number, and so on. The theoretical expectations also extend to the last digits of a number, as well as to second order differences. For clarity, first order is a term of art in the context of Benford's Law and Zipf's Law, and references a statistical test performed when no differences are calculated among digits within numerical records of a dataset. A second order test is one based on the digits of the differences (or subtracted values) between numerical records that have first been sorted from smallest to largest.

For purposes of limiting exposition of the present invention to a more salient review of key attributes, examples will be limited to the first and first two digits of targeted numbers and to first order tests. However, this is not intended to exclude the potential applicability of other theoretical expectations of Benford's Law from the scope of the present invention. Further, the statistics and processes described herein with respect to Benford's Law are equally applicable to Zipf's Law and other data analysis methods as with the Pareto Distribution. Finally, the present invention draws a distinction between numbers with positive values and numbers with negative values for purposes of performing statistical analyses. In the world of accounting, for example, a positive number reflects a gain while a negative number reflects a loss, and such distinctions are important.

Referring now to FIG. 1, the process 100 begins by opening the User Interface 110, which is accomplished by clicking on a User Interface icon located on a personal computer, mobile device, or the internet. In a mainframe environment the process may start with a call to the application. Once the User Interface 110 is opened, a user then loads input documentation 120 that is to be reviewed. Input documentation may consist of a single file, or a batch of files. The user then loads an output template file 130 where analytic results are reported. The output template file may be provided with a logo or text by the user prior to the output template file being referenced for the reporting of analytic results. A user next indicates if there are any number-types to be excluded from analysis 140, and examples of these may be numbers that are duplicated within input documentation, or zip codes or years or any other types of numbers that a user deems to be inappropriate for a data analysis method such as Benford's Law. Number-types that are automatically excluded from consideration by the application are phone numbers, numbers with a hyphen unless the hyphen designates a negative value, numbers with leading zeroes, and numbers that are used in conjunction with letters or symbols for identification purposes as when part of a URL or registration code. A user then selects a subset allocation process if applicable 150, selects whether a Batch Report is to be created if applicable 160, and then runs the application 170. After the application is run, output documentation is provided 180 in the form of a Results Report, an Audit Trail Report, and a Batch Report if applicable.

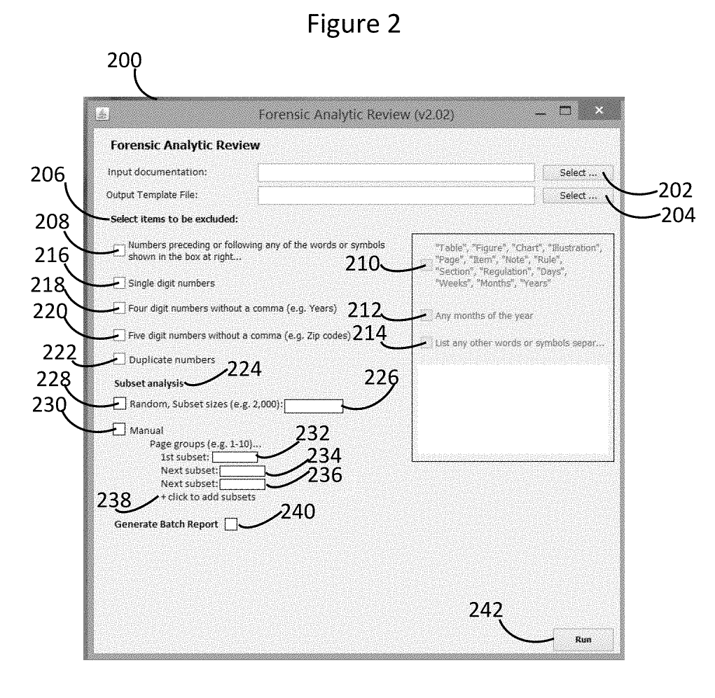

FIG. 2 illustrates a preferred embodiment of a User Interface 200. A user loads their input documentation 202, and this may be in the context of a single document or multiple documents contained within a folder in batch mode. Next a user loads an output template file 204 which the application references to publish the results of analytics performed on the numbers culled from input documentation at step 202. If there are any numerical data that a user desires to have excluded from analysis, a user has the opportunity to flag those particular records in a variety of ways 206. If a user desires to exclude numbers preceding or following certain words or symbols 208, a user can select the option that achieves this in the context of terms such as “Table”, “Figure”, “Chart”, or a variety of other contexts 210. If a user desires to exclude numbers associated with months of the year, then option 212 may be selected. If a user desires to add their own rules for when certain records ought to be excluded, this is possible as well 214. If a user wants to exclude certain classes of records as with single digit numbers 216, or four digit numbers without commas such as years 218, or five digit numbers without commas such as zip codes 220, then these options are available. And if a user wants to exclude duplicate numbers 222, this option is also available.

Continuing with FIG. 2, a user may desire that subset analysis be performed 224. For especially large datasets, a subset analysis may help evaluate conformity with Bedford's Law in a more meaningful way with regards to evaluating statistical significance. For a user desiring this additional analysis, they may choose to have records within a dataset evaluated on the basis of numbers being selected at random 228, or on the basis of a manual process 230. The manual process 230 requires a user to specify how subsets are to be created with reference to pages contained within input documentation 202. For the random process 228 the user must specify how many records are to be assigned to each subset that is created, and this is indicated at 226. With the manual process 230, the user indicates respective groupings of page numbers at 232, 234, and 236 which reference the input documentation 202. If additional subsets are desired beyond 232, 234, or 236, the user may create more by clicking on the plus sign and supplying the requisite references 238.

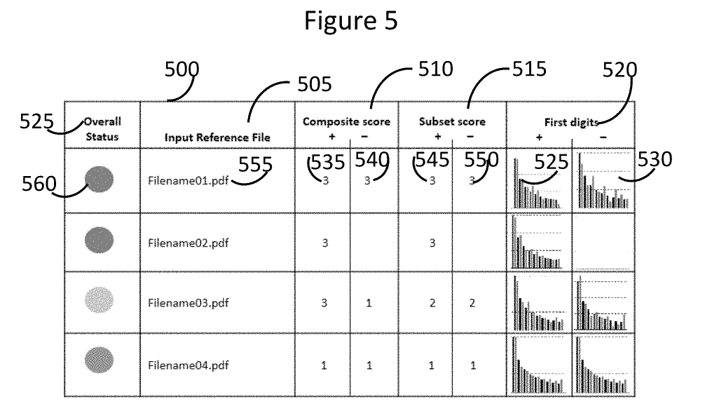

Continuing with FIG. 2, if multiple input documents are uploaded 202, then a user has the option to request the generation of a Batch Report 240. A Batch Report provides a high level overview of each document uploaded at 202 when multiple documents are involved, and the Batch Report is detailed in FIG. 5.

To complete the explanation of FIG. 2, when a user is ready to run the application, the Run button 242 is selected.

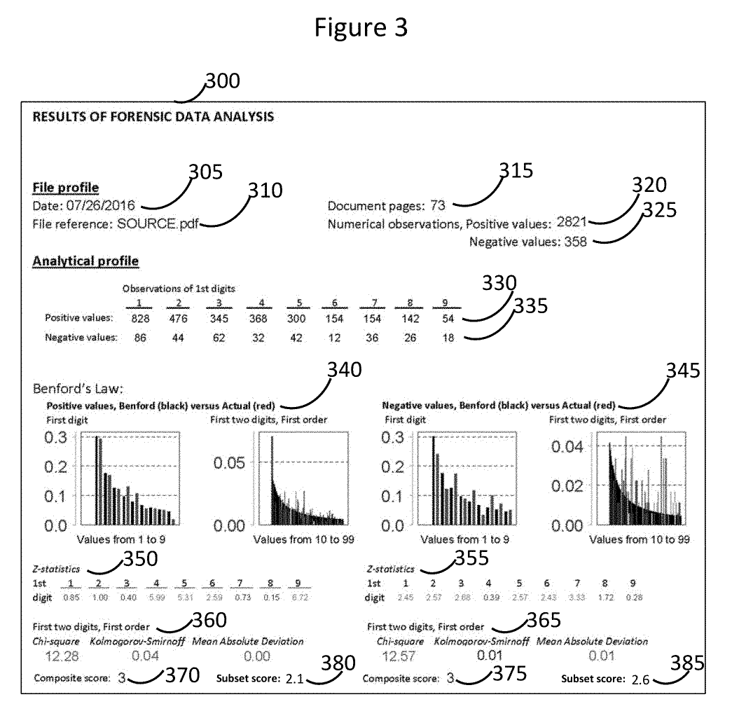

FIG. 3 presents a preferred embodiment of a Results Report 300 which presents analytical findings culled from the records collected from input documentation provided at step 202 in FIG. 2. The Results Report as shown in FIG. 3 indicates the date the analysis was performed 305, the name of input documentation 310, the number of pages 315 contained in input documentation, and the number of positive values 320 and negative values 325 culled from input documentation. The Results Report 300 additionally provides the number of positive value records culled from input documentation per leading first digit 330, as well as the number of negative value records culled from input documentation per leading first digit 335. The sum of positive values at row 330 sums to the same number reported at 320, and the sum of negative values at row 335 sums to the same number reported at 325.

Continuing with FIG. 3, the Results Report 300 additionally presents charts of Benford's Law expected values alongside actual results for the case of positive values 340, and with expected values represented with black bars and actual results represented with red bars. In this preferred embodiment the two charts for positive values show expected versus actual results for first digits and for first two digits, first order. The Results Report 300 also presents charts for the case of negative values 345, and these are also shown with Benford's Law expected values represented with black bars and actual results represented with red bars. The two charts for negative values show expected versus actual results for first digits and for first two digits, first order.

Continuing further with FIG. 3, the Results Report 300 additionally presents Z-statistics for first digit positive values 350, and Z-statistics for first digit negative values 355. Further, when Z-statistics are not meaningful at a five percent level of statistical significance, Z-statistic values are reported in red and are otherwise reported in black. Other statistical results shown in the Results Report 300 include Chi-Square, Kolmogorov-Smirnoff, and Mean Absolute Deviation for positive records 360 as well as negative records 365. Further, when Chi-Square values are not meaningful at a five percent level of significance for a two-tailed test, and when Kolmogorov-Smirnoff values are not meaningful at a five percent level of significance, results are reported in red and are otherwise reported in black. Additionally, when actual Mean Absolute Deviation values are above a value of 0.0022, results are reported in red and are otherwise reported in black.

Continuing further with FIG. 3, the Results Report 300 additionally presents a Composite score for positive values 370 which represents a synthesis of results obtained from positive value Z-statistics, Chi-square, Kolmogorov-Smirnoff, and Mean Absolute Deviation, and a Composite score for negative values 375 representing a synthesis of results obtained from negative value Z-statistics, Chi-square, Kolmogorov-Smirnoff, and Mean Absolute Deviation. In one preferred embodiment, the Composite score for positive values 370 and Composite score for negative values 375 are calculated with reference to a scale ranging from one to three, where a low value is preferable to a high value, and where values are determined on the basis of the deviation of actual values relative to statistically significant values. According to a preferred embodiment the Composite score is be computed separately for positive values and negative values, and such that Z-statistics, Chi-squares, Kolmogorov-Smirnoffs, and Mean Absolute Deviations are synthesized into a single Composite score for positive values and a separate single Composite score for negative values. That process consists of the following five steps which are applicable for both positive values and negative values:

First, respective Z-statistics are summed across each first digit, and this sum is divided by nine as there are nine first digit possibilities. If the calculated result is less than 1.96 which is the cutoff value for five percent statistical significance, then the contribution to the Composite score is zero and otherwise the contribution to the Composite score is the calculated result.

Second, if the calculated Chi-square for the first two digits is greater than 116.989 or less than 64.793 which are cutoff values for the relevant degrees of freedom with reference to a five percent statistical significance and a two-tail test, then the contribution to the Composite score is zero and otherwise it is 1.

Third, if the calculated Kolmogorov-Smirnoff for the first two digits is less than the cutoff value for a five percent statistical significance, and with the cutoff value being 1.36 divided by the square root of the number of records being analyzed for a five percent statistical significance, then the contribution to the Composite score is zero and otherwise it is the calculated result less the cutoff value and with this difference multiplied by a factor of 10.

Fourth, if the calculated result for Mean Absolute Deviation for the first two digits for positive values is less than 0.0022 which is the cutoff value for statistical significance, then the contribution to the Composite score is zero and otherwise it is the calculated result less the cutoff value and with this difference multiplied by a factor of 10.

Fifth, if aggregated outcomes for the preceding calculations described in the first, second, third, and fourth steps amount to a sum of between zero and 3.0 then the Composite score is reported as 1, and if aggregated outcomes amount to a sum of between 3.1 and 6.0 then the Composite score is reported as 2, and if aggregated outcomes amount to a sum of 6.1 or higher then the Composite score is reported as 3.

Continuing further with FIG. 3, the Results Report 300 presents a Subset score for positive values 380 and negative values 385. At the option of the user, a Subset analysis can be performed on records culled from input documentation per user specifications as detailed in FIG. 2. The Subset scores 380 and 385 are calculated with reference to a scale ranging from one to three, where a low value is preferable to a high value, and where values are determined on the basis of the deviation of actual values relative to statistically significant values.

According to one preferred embodiment, the Subset score can be computed for positive values and negative values separately, and such that the Subset score conveys an overall statistical consistency of results with respect to especially large datasets.

Specifically, a Benjamini-Hochberg Procedure (or equivalently, a B-H Step-up Procedure) is used, and for three reasons.

First, the Benjamini-Hochberg Procedure references p-values, and each of the previously cited statistical tests related to an analysis of all numbers at once have p-values, inclusive of Chi-square, Kolmogorov-Smirnoff, and Mean Absolute Deviation. For clarity, Z-statistics have p-values, but Z-statistics are reported on a digit-by-digit basis, or digits-by-digits basis, as opposed to being a measure reflective of an all numbers at once approach where only one statistical outcome is generated per statistical metric; that is, the calculation of Chi-square results in a single number, the calculation of Kolmogorov-Smirnoff results in a single number, and the calculation of Mean Absolute Deviation results in a single number.

Second, the Benjamini-Hochberg Procedure is a commonly applied method when multiple comparisons are involved across subsets of data.

Third, results obtained with the Benjamini-Hochberg Procedure are easily translated into a composite Subset score. In a preferred embodiment of the present invention, the Benjamini-Hochberg Procedure is applied to Chi-square, Kolmogorov-Smirnoff, and Mean Absolute Deviation, and with values individually calculated with respect to each one of these metrics at a statistical significance of five percent. If 80.0 percent or more of subsets qualify for significance status with respect to Chi-square, Kolmogorov, or Mean Absolute Deviation, then a scalar value of 1 is assigned. For example, if Chi-square is the metric under consideration, when 80.0 percent or more of subsets qualify as being statistically significant, then the Chi-square metric is assigned a scalar value of 1. If 60.0 percent up to 79.9% of subsets qualify for significance status then a scalar value of 2 is assigned, and if 59.9 percent or fewer of subsets qualify for significance status then a scalar value of 3 is assigned.

A Subset score is then calculated on the basis of a simple averaging of the three values generated for Chi-square, Kolmogorov-Smirnoff, and Mean Absolute Deviation with reference to the Benjamini-Hochberg Procedure. For example, if the Chi-square scalar value is 1, and the Kolmogorov-Smirnoff scalar value is 2, and the Mean Absolute Deviation scalar value is 1, then the simple average of these three scalar values is 1.3 and 1.3 is then reported as the Subset score.

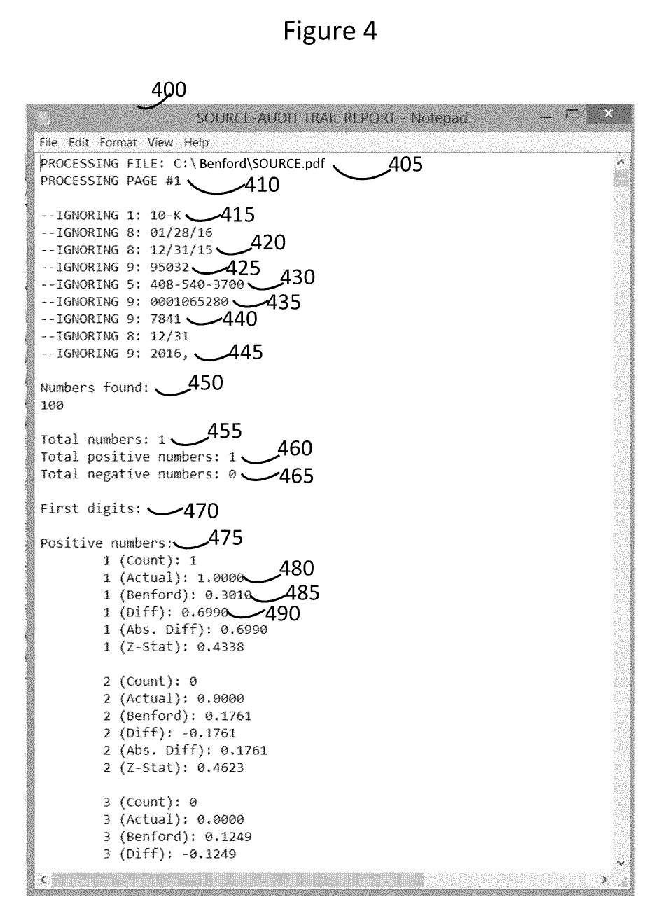

FIG. 4 shows the initial portion of the Audit Trail Report 400, where the first elements include citations of input documentation 405 and the page number being referenced from that documentation 410. The Audit Trail Report provides a detailed profile of each page contained within the input documentation.

Continuing with FIG. 4, the Audit Trail Report 400 additionally indicates the records excluded in the process of culling numbers from input documentation. For example, references to terms such as 10-K 415, or dates 420, or zip codes 425, phone numbers 430, record numbers 435, four digit numbers without a comma 440, or years 445, are all examples of numbers that are not appropriate for a Benford's Law analysis. Other record-types that would be excluded are numbers that refer to tables and charts, or regulations, or numbers embedded within a reference such as a URL, among others.

Continuing with FIG. 4, the Audit Trail Report 400 additionally indicates the particular records found 450 within input documentation for the particular page being profiled, the total number of records found 455, the number of those records that were positive values 460, and the total number of those records that were negative values 465. These values at 460 and at 465 constitute the relevant records for purposes of subsequent calculations performed.

Continuing with FIG. 4, the Audit Trail Report 400 then provides a first digit profile 470, where details of each relevant first digit record indicated at 455 is accounted for in terms of its expected value under Benford's Law 485, its actual value under Benford's Law 480, the difference of actual values 480 and expected values 485 as reported at 490, and other calculations. A comparable profile is also provided within the Audit Trail Report for the negative values identified within input documentation.

Other elements of the Audit Trail Report 400 include a profile of relevant positive and negative values of the first two digits of each individual page within input documentation, as well as an aggregate summary profile of all relevant positive and negative values of first digits and first two digits culled from input documentation. It is the analysis of the aggregated data which is provided in the Results Report as detailed in FIG. 3. The Audit Trail Report 400 also provides a composite list of all relevant positive and negative values culled from input documentation, as well as details related to subset analytics when a user requests this feature for especially large datasets, or details related to duplicate numbers when a user invokes this option.

FIG. 5 presents the profile of a preferred embodiment for a Batch Report. The Batch Report is intended to provide a high level overview of analytical results for each input documentation loaded into the application within batch mode. Names of individual files 505 uploaded in the batch mode are cited 555, along with their respective Composite score 510 for positive values 535 and negative values 540, and Subset score 515 for positive values 545 and negative values 550. The Batch Report also provides charts showing the relationship between expected first digit distributions 520 in the context of Benford's Law versus actual results obtained for both positive values 525 and negative values 530. The Batch Report also provides an overall status 525 of each document, and this is represented as a colored circle 560 that is shown in green, amber, or red. A document's color is determined by the average value of the document's Composite score 510 for positive values 535 and negative values 540, and Subset score 515 for positive values 545 and negative values 550. If a user elected not to have a Subset analysis performed, then the document's color is determined only by the average value of the document's Composite score 510 for positive values 535 and negative values 540. When average values are between 1.0 and 1.5 the color is set to green, when average values are between 1.6 and 2.5 the color is set to amber, and when average values are between 2.6 and 3.0 the color is set to red. The color green would be indicative of a favorable overall status and statistical conformity with Benford's Law, while amber would be indicative of an overall status suggesting some deviation from Benford's Law, and red would be indicative of an overall status indicating non-conformity with Benford's Law.

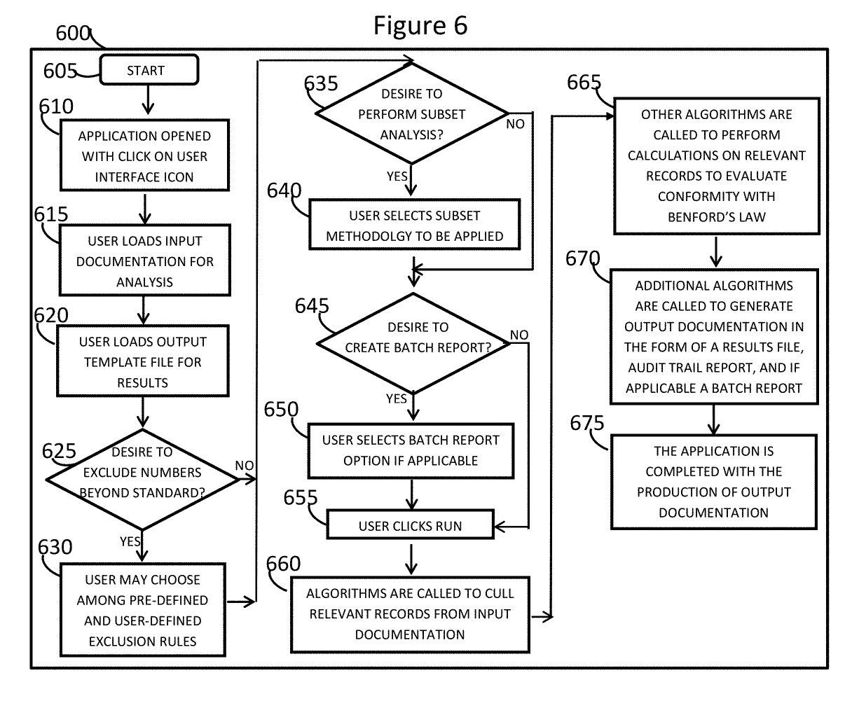

FIG. 6 provides a detailed overview for a preferred embodiment of the present invention 600 in relation to process. The process starts 605 with a user opening the User Interface 610. If the User Interface resides on a personal computer, mobile device, or the internet, it can be opened by clicking on a User Interface icon. In a mainframe environment the process may start with a call to the application. When the User Interface is opened, a single window is displayed where the user may enter key information as detailed in FIG. 2.

Continuing with FIG. 6, the first item provided by the user is input documentation 615 which contains the records to be culled by the application. The user may provide a single input document or multiple input documents contained within a folder to be processed in a batch mode. The user is also required to load an output template file 620 which is where analytic results will be reported once the application has completed running.

Continuing with FIG. 6, the user is additionally provided with an opportunity to exclude numbers from analysis 625 beyond those records that are counted as standard exclusions. Standard exclusions involve numbers not regarded as appropriate for a data analysis method such as Benford's Law, and examples of these are phone numbers, single digit numbers within parentheses, numbers associated with letters as with labels for tables or charts, registration codes, numbers that lead with zeroes, numbers that appear within strings having letters as with URLs, and other related constructs. Additional exclusions that a user may select are single digit numbers, four digit numbers without commas as with years, five digit numbers without commas as with zip codes, numbers that appear with text such as “Table”, “Figure”, “Chart”, or other such labels, and numbers linked to a month of the year such as “December 31”. A user also has the opportunity to manually enter any words or symbols to serve as additional flags for excluding numbers, as with “%” or “percent”.

Continuing with FIG. 6, after a user identifies record-types to be excluded from analysis 630 if any, the user may elect to have subset analyses 635 performed on the relevant records culled from input documentation. Subset analyses may be particularly helpful with especially large datasets. While there is subjectivity as to how many records constitute an especially large dataset, a common point of demarcation is around 2,000 to 2,500 records. Accordingly, for datasets that may run into the millions of records, an ability to evaluate these in a statistically meaningful way can be particularly helpful. To accommodate this scenario, the user has the option of having their dataset be subject to additional analysis 640 to evaluate conformity with Benford's Law when datasets are especially large. For example, a user may elect to have an especially large dataset of 10,000 records be allocated across five subsets of 2,000 records each, and the options 640 for how those allocations may be made are detailed in FIG. 2.

Continuing with FIG. 6, if the user desires to create a Batch Report 645 when multiple documents are involved 615, then the user has the option to request that such a report 650 be generated. When the user then clicks Run 655, algorithms within the application are called for culling relevant records 660 from input documentation 615, performing calculations to determine conformity with Benford's Law 665, and generating output documentation in the form of a Results Report and an Audit Trail Report, and a Batch Report if applicable 670. With those documents created the application process is complete 675.

What is claimed is:

1. An apparatus for targeting especially large volumes of numerical records within alphanumeric documentation, said apparatus comprising: a computer program application tangibly embodied on a machine-readable storage device for culling targeted numerical records, the computer program application including instructions operable to cause data processing apparatus to perform operations comprising statistical analysis relative to a data analysis method and the reporting of analytic results.

2. The apparatus according to claim 1, wherein targeted numerical records that are culled for statistical analysis are of relevance to Benford's Law as a data analysis method.

3. The apparatus according to claim 1, wherein targeted numerical records that are culled for statistical analysis are of relevance to Zipf's Law as a data analysis method.

4. The apparatus according to claim 1, wherein targeted numerical records that are culled for statistical analysis relative to a data analysis method are evaluated in the context of statistical significance according to Z-statistics, Chi-square, Kolmogorov-Smirnoff, and Mean Absolute Deviation.

5. The apparatus according to claim 4, wherein results of statistical analysis may be translated into scalar values that can be averaged into a composite score.

6. The apparatus according to claim 1, wherein the data analysis method is applied to any digits of targeted numerical records that are culled for statistical analysis.

7. The apparatus according to claim 1, wherein positive numerical values are processed separately from negative numerical values with reference to digits of targeted numerical records that are culled for analysis.

8. The apparatus according to claim 1, wherein certain number-types are automatically excluded from targeting as with phone numbers, numbers with a hyphen unless the hyphen designates a negative value, numbers with leading zeroes, and numbers used in conjunction with letters or symbols for identification purposes as when part of a URL, registration code, or label.

9. The apparatus according to claim 1, wherein rules for excluding number-types from targeting may be created by the user.

10. The apparatus according to claim 1, wherein especially large volumes of targeted and culled data may be allocated into subsets for statistical analysis and reporting.

11. The apparatus according to claim 10, wherein especially large volumes of targeted and culled data may be distributed into subsets on the basis of random allocations.

12. The apparatus according to claim 10, wherein especially large volumes of targeted and culled data may be distributed into subsets on the basis of user-specifications.

13. The apparatus according to claim 10, wherein the subsets that are created for statistical analysis are evaluated relative to a data analysis method, with statistical significance determined according to Z-statistics, Chi-square, Kolmogorov-Smirnoff, and Mean Absolute Deviation.

14. The apparatus according to claim 13, wherein results of statistical analysis may be translated into scalar values that can be averaged into a subset score with reference to the Benjamini-Hochberg Procedure.

15. The apparatus according to claim 1, wherein alphanumeric documentation may be provided for statistical analysis as a single document.

16. The apparatus according to claim 1, wherein alphanumeric documentation may be provided for statistical analysis as multiple documents in a batch process.

17. The apparatus according to claim 1, wherein the reporting of analytic results is provided within an output template file.

18. The apparatus according to claim 1, wherein the reporting of analytic results is additionally provided within an audit trail report.

19. The apparatus according to claim 1, wherein the reporting of analytic results is additionally provided within a batch report.

20. The apparatus according to claim 19, wherein in the batch report presents an analytical profile at a high level for each document when a batch process is used.

21. The apparatus according to claim 1, wherein the application may be run as a standalone application that resides on a personal computer, mobile device, mainframe, or the internet.

22. The apparatus according to claim 1, wherein the application may be run as a complementary application with an existing or future data analysis tool.
